(19) United States
(12) Patent Application Publication
(10) Pub. No.: US 2009/0255176 A1
(43) Pub. Date: Oct. 15, 2009

(54) Decontamination process of wide land areas

(76) Inventor: Giusto Giovannetti, Torino (IT)

Correspondence Address: NIXON & VANDERHYE, PC, 901 NORTH GLEBE ROAD, 11TH FLOOR, ARLINGTON, VA, 22203, US

(21) Appl. No.: 12/310,780

(22) PCT Filed: Sep. 7, 2006
(86) PCT No.: PCT/IT2006/000647

§ 371 Date: Mar. 6, 2009

(51) Int. Cl. A01G 1/00

(52) U.S. Cl. 47/58.1 SC

(57) ABSTRACT

Procedure for the decontamination of a large area of land from organic pollutants, including the phases of: a) sowing and cultivating an annual and/or perennial plant on the land to be decontaminated; b) inoculating the plant with a microbiological consortium of the rhizosphere; and c) applying to the land at least one surfactant substance, where the metabolic activity of the microbiological consortium of the rhizosphere causes the decomposition of the organic pollutants present in the soil.

The present invention concerns a procedure for decontaminating wide land areas, whether they consist of agricultural land or industrial land, contaminated by pollutants that are soluble or insoluble in water, including the use of microbiological consortia of the rhizosphere.

### TECHNICAL BACKGROUND OF THE INVENTION

The soil plays a fundamental role in the biosphere, making possible plant life and the completion of the principal biogeochemical cycles. Alongside a wide variety of inorganic compounds, it also contains a very large number of organic compounds, frequently the metabolites of the many species that populate it. A normally stable soil is characterised by a rich microbial population, whereas a soil with low specific diversity represents a stressed environment with a very reduced microbial population and it is an indicator of a situation of pollution.

The microbial population that lives in the soil, whose biomass may reach numerous tons per hectare in the superficial layer, is directly involved in the biodegradation process of contaminants and constitutes the so-called microbiological consortium of the soil. The largest presence of micro-organisms in the soil may be found in the rhizosphere. The microbiological consortium of the rhizosphere comprises, among other micro-organisms, bacteria and fungi. Bacteria and fungi are highly versatile micro-organisms, capable of performing all known organic/biological reactions, such as for example the decomposition of organic substances. These micro-organisms are heterotrophic, that is they do not possess the capability of synthesising the organic compounds required for their survival, but must be capable of decomposing organic substances naturally present in the soil in order to absorb the compounds resulting from decomposition (metabolites) from the surrounding environment. These micro-organisms may thus be used to advantage in procedures to decontaminated land polluted by organic substances chiefly, but not exclusively, of synthetic origin.

As of today, procedures are available to decontaminate relatively small areas of land (in the order of a few square kilometres) from organic pollutants (for example polychlorinated biphenyls) that essentially consist of excavating the soil and disposing of it in landfills, with very high environmental and economic costs.

### DESCRIPTION OF THE INVENTION

The purpose of the present invention is to develop a procedure for the widespread decontamination of wide land areas polluted—at relatively low concentrations—with hydrosoluble organic substances, such as for example agricultural chemicals, and/or liposoluble organic substances, such as for example polychlorinated biphenyls and polycyclic aromatic hydrocarbons, substituted and not, by using micro-organisms of the rhizosphere naturally present in the soil.

According to the present invention, this purpose is achieved thanks to the solution described in detail in the attached claims. The claims for an integral part of the technical instruction provided here in regard to the invention.

In an embodiment at present preferred, the present invention concerns a procedure that provides for the use of microbiological consortia of the rhizosphere in combination with surfactants, and in particular bio-surfactants, and the cultivation of annual and/or perennial plants to eliminate the pollutants present in the soil.

### DETAILED DESCRIPTION OF THE INVENTION

The invention will now be described in detail in regard to some embodiments at present preferred, as a simple example without limiting intent.

The procedure to decontaminate the soil subject of the present invention essentially provides for the bio-degradation of organic contaminants of the soil through the use of a microbiological consortium of the rhizosphere.

From indications obtained from experiments carried out by the Applicant, it may be said that the decontamination of wide areas, such as for example Piedmont, Lombardy or even the entire Po Valley, affected by widespread pollution, by applying the procedure according to the present invention, is achieved by restoring in the polluted soil an optimal microbial presence, typical of a good-quality agricultural soil, and intervening on the degree of bio-availability of the contaminant through the addition of bio-surfactant substances that—forming complexes with the contaminant molecule—favour its attack by microbes. All of this operating in synergy with the cultivation of an annual and/or perennial plant on the land to be decontaminated that acts as a support for the development of the microbiological consortium of the rhizosphere. Bio-surfactants can be added directly to the soil (using compounds available on the market) or indirectly by adding micro-organisms capable of producing them, this latter solution being markedly more sustainable in economic terms.

On the basis of trials carried out by the Applicant and of the results obtained when testing the procedure subject of the present invention it may be said that the procedure leads to a decontamination of the area of interest (with extensions in the order of tens of hectares) over a time-frame of approximately two to three years, since the reduction of the contaminants present in the soil is approximately equal to 30-50% per year.

It may also be said that the presence of microbiological consortia of the rhizosphere, that act as a filter for the pollutant substances present in the soil, enables the plants to absorb the soil contaminants to a lesser extent, such that they may be introduced into the food chain without risk for the consumer.

The results obtained by the Applicant in an agricultural context open a new perspective in the reclamation of land with widespread contamination and a new role of the farmer as an active subject in environmental reclamation. Indeed, in relation to the trials undertaken by the Applicant, the best results in terms of i) degradation of soil contaminants, ii) interruption of the transmission of contaminants in the soil-plant passage, and iii) economic self-support of the farms affected by contamination events (chiefly deriving from the possibility of using the plants as animal feed) are given by a procedure comprising the phases of:
a) cultivation of an annual plant that can be destined for use as human and/or animal food, such as for example maize;
b) inoculation of the plant with a microbiological consortium of the rhizosphere; and
c) application onto the land of bio-surfactants, preferably of micro-organisms capable of producing bio-surfactants.

The present invention is of absolute interest considering the widespread nature of the problem of contaminated land and also in consideration of the fact that the most recent environmental legislation (Decree Law 152/06) has had to raise the concentration limits, for example for polychlorinated biphenyls (PCBs), in land for residential use (for regional regulations) from 0.001 mg/kg to 0.06 mg/kg, since as of today procedures for environmental reclamation do not exist that enable even the limit of 0.06 mg/kg to be achieved. The present invention is thus put forth as the only procedure to effect an environmental reclamation that is widespread over large areas.

A further indication of equal interest deriving from the trials done by the Applicant is related to the reclamation of areas contaminated by polychlorinated biphenyls (PCBs). Unlike an agricultural context, reclamation of a contaminated residential and/or industrial area aims to detoxify a small area which is the site of industrial activity without having to take into account factors determined in the agricultural sphere, such as self-support of the farm, transmission of the contaminants along the food chain, etc. For these reasons, the best results that can be achieved in a non-agricultural context in terms of i) degradation of the contaminant in the soil, ii) better capability of absorbing the contaminant from the soil by the plant and iii) consequent reduction of reclamation times, may be achieved through a procedure comprising the phases of:
a) cultivation of an annual and/or perennial plant, possibly characterised by a high capability to accumulate toxic substances, such as for example maize, hemp or poplar;
b) inoculation of the plant with a microbiological consortium of the rhizosphere; and
c) application onto the land of bio-surfactants, preferably of micro-organisms capable of producing bio-surfactants.

Despite the time-frame of two-three-four years required for reclamation, this system represents the only reclamation method that is possible for widespread contamination of wide land areas, characterised by a high degree of economic and environmental sustainability.

### Composition of the Microbiological Consortium of the Rhizosphere

The microbiological consortium of the rhizosphere essentially consists of mycorrhizae, bacteria, actinomycetes, saprophytic fungi and micromycetes. MycQrrhizae are symbiotic consortia that are set up between the roots of many plants and fungi of the sub-soil (mycorrhizal fungi). It is believed that they were fundamental in the process of colonising the continents and, still today, they are necessary for today's plant life. However, in areas affected by human settlement, such as cultivated fields, mycorrhizae are frequently absent, or present in a very reduced form, probably due to chemical pollution of the land.

Mycorrhizae are subdivided into two principal groups: ectomycorrhizae and endomycorrhizae.

Ectomycorrhizae are able to colonise only a small number of plant species, almost all forest trees (conifers and broad-leaved trees) but are of little importance for agricultural crops. They are defined as ectomycorrhizae because they do not penetrate into the tissues, but form a thick layer of mycelium (mantle) around the roots. There are approximately 5000 known species of ectomycorrhizae. They generate spores as a form of survival and diffusion, which are transported by the wind, animals or man's activities. Truffles are the best known expression of this type of mycorrhizal symbiosis.

The endomycorrhizae are obligate symbionts. Unlike the first group, they penetrate inside the tissues and cells of the host without ever perforating cell walls, but do not form an external fungal mantle. They establish themselves on the cortical part of the root, penetrating its cells and filling the inter-cellular spaces without however ever invading the central cylinder. Inside the cells they may form ovoid structures known as vesicles and branched structures known as arbuscules. Externally the mycelium may expand around the root for some centimetres.

Endomycorrhizae may be subdivided into five subgroups. In the commonest type (the vesciular-arbuscular mycorrhizae, also known as VAM) the fungus, which grows in the ground, penetrates into the root cells where it forms branched structures (arbuscules). It is in the arbuscules that nutritional exchanges take place: the fungus absorbs the nutrient elements from the ground, in particular phosphorus, potassium and some micro-elements, and makes them available to the plant, receiving in exchange processed sap. The formation of mycorrhizae gives the plant a better capability to absorb water and protects it against the attack of some root pathogens. The sum of these effects guarantees better growth for mycorrhized plants.

Mycorrhizae are capable of solubilising and, therefore, absorbing the organic or mineral forms present in the soil in the form of insoluble compounds, not directly usable by the plants, radically altering the agronomic budget of availability of nutrient elements in the ground. The increased absorption of mineral salts from the soil (P, N, Ca, K, Fe, Mg, Cl, Zn, Cu) changes the equilibrium and composition of nutrients in the plant tissues, with consequences on the yield of photosynthesis, which is increased, and on the subdivision of the products of photosynthesis between the roots and the aerial parts of the plant. 20% of the total C assimilated by the plant may be transferred to the fungus.

The bacteria in the rhizosphere, the actinomycetes, the saprophytic fungi and the micromycetes create a chain of assimilation capable of extracting the nutrients naturally present in the soil, making them available to the plant and metabolising the carcinogenic substances.

Table 1 shows the major components of a particular embodiment of the microbiological consortium of the rhizosphere used in the sphere of the present invention.

TABLE 1

| | | | | Endo- |
|---|---|---|---|---|
| | Saprophytic | | Bacteria of the | mycorrhizal |
| Micromycetes | fungi | Actinomycetes | rhizosphere | fungi |
| Mortierella | Trichoderma | Streptomyces | Pseudomonas spp. | Glomus spp. |
| isabellina | spp. | spp. | | |
| Aspergillum | Trichoderma | Streptomyces | Pseudomonas | Glomus |
| spp | harthianum | griseus | borealis | coronatum |
| Aspergillum | Trichoderma | Streptomyces | Pseudomonas | Glomus |
| niger | viridae | avermitilis | fluorescens | caledonium |
| Sclerotium | Trichoderma | | Pseudomonas | Glomus |
| spp. | aureoviridae | | synxantha | intreradices |
| Ulocladium | Trichoderma | | Pseudomonas | Glomus |
| spp. | atroviridae | | corrugata | viscosum |
| Ulocladium | Trichoderma | | Pseudomonas | Glomus |
| oudemansii | koningii | | aeroginosa sp. | mosseae |
| Arthrobotrys | Trichoderma | | Pseudomonas | Glomus |
| spp. | harzianum | | aeroginosa | glomaceae |
| Arthrobotrys | Trichoderma | | Bacillus spp. | Glomus |
| oligospora | virens | | | fasciculatum |
| Fusarium spp. | Trichoderma | | Bacillus | Glomus |
| | an. of | | subtilis | claroideum |
| | Hypocrea | | | |
| | schwlinitzi | | | |
| Mucor spp. | Trichoderma | | Bacillus | Glomus |
| | viride | | megaterium | etunicatum |
| Pichia spp. | Coniothyrium | | Bacillus | Glomus |
| | spp. | | polymyxa | epigaeum |
| Pichia | Coniothyrium | | Bacillus | Glomus |
| pastoris | minitans | | licheniformis | lamellosum |
| | Gliocadium | | Alcanivorax spp. | Glomus |
| | spp. | | | monosporum |
| | Gliocadium | | Alcanivorax | Acaulospora |
| | calenulatum | | venetianus | spp. |
| | Beauveria spp. | | Candida spp. | Acaulospora |
| | | | | longula |
| | Beauveria | | Rhodococcus spp. | Acaulospora |
| | bassiana | | | laevis |
| | | | Rhodococcus | Gigaspora |
| | | | rythropolis | spp. |
| | | | Acinetobacter spp. | Gigaspora |
| | | | | ramisporophora |
| | | | Acinetobacter | Gigaspora |
| | | | calcoaceticus | gigantea |
| | | | Acinetobacter | Gigaspora |
| | | | Radioresistens | margarita |
| | | | Mycobacterium spp. | Gigaspora |
| | | | | rosea |
| | | | Mycobacterium | Gigaspora |
| | | | thermoautotrophium | calospora |
| | | | Agrobacterium spp. | Scutellospora |
| | | | | spp. |
| | | | Agrobacterium | Scutellospora |
| | | | radiobacter | calospora |
| | | | Serratia spp. | |
| | | | Serratia | |
| | | | marcescens | |

The composition of the inoculum of the mycorrhizal consortium of the rhizosphere presents, in an embodiment at present preferred, the following minimum content of microbiological components:
i) endomycorrhizal fungi are present in a minimum percentage of 6%, preferably 10-20%, by weight with respect to the total weight of the product;
ii) bacteria of the rhizosphere are present to a minimum extent of 1×10⁶ CFU/g, preferably 5-10×10⁶ CFU/g, of dry weight with respect to the total weight of product;
iii) antagonistic saprophytic fungi and micromycetes are present to the minimum extent of 1×10⁶ CFU/g, preferably 5-10×10⁶ CFU/g, of dry weight with respect to the total weight of product;
iv) actinomycetes are present to the minimum extent of 1×10⁶ CFU/g, preferably 5-10×10⁶ CFU/g, of dry weight with respect to the total weight of product; and
v) micromycetes are present to the minimum extent of 1×10⁶ CFU/g, preferably 5-10×10⁶ CFU/g, of dry weight with respect to the total weight of product.

### Surfactants and Bio-Surfactants

Surfactants are amphipathic molecules composed of a hydrophilic part and a hydrophobic part (generally hydrocarbon) that preferentially position themselves at the interface between fluid phases with different degrees of polarity and hydrogen bonds such as, for example, the oil/water interface or the air/water interface. These characteristics make surfactants capable of reducing the surface tension and of forming microemulsions where substances that are generally insoluble in water, such as hydrocarbons, may be solubilised in water or water in the hydrocarbons. These characteristics give surfactants excellent properties as detergents, emulsifiers, foaming agents and dispersants. Almost all surfactants currently on the market are chemical derivatives of petroleum.

Bio-surfactants are surfactants of microbial origin that are diversified structurally and that are much less harmful for natural ecosystems. Examples of micro-organisms capable of producing bio-surfactants include Pichia pastoris, Acinetobacter calcoaceticus, Acinetobacter radioresistens, Pseudomonas aeruginosa, Rhodococcus spp., Bacillus subtilis, Candida bombicola, Alcanivorax borkumensis, and Alcanivorax venetianus.

Other surfactants that may be used to advantage in the sphere of the present invention are cyclodextrins and polyethylene sorbitol esters.

Experts in the field will have no difficulty in identifying any other surfactants or bio-surfactants that can be used to advantage in the sphere of the procedure to decontaminate polluted land according to the present invention.

### Composition of the Inoculum

The inoculum of mycorrhizal fungi that can be used in the sphere of the procedure according to the present invention is a microbiological consortium that preferably contains:
arbuscular mycorrhizal fungi;
bacteria of the rhizosphere; and
saprophytic fungi.

The microbiological inoculum of bio-surfactants contains bio-surfactant fungi and/or bacteria.

The quantities of the microbiological consortium and of the bio-surfactants, that must be distributed per hectare, in an embodiment at present preferred, respect the ratio of 1:9.

Tables 2 and 3 relate—in an embodiment at present preferred—to the product to be distributed on the surface of one hectare and provide for 100 kg of microbiological consortium of the rhizosphere (table 2) and 900 kilograms of bio-surfactants (table 3).

TABLE 2

| | | Percentage | Biological |
|---|---|---|---|
| | | composition | composition |
| Component | Formulation | (by weight) | (minimum) |
| Organic substratum | Granular | 36% | |
| | Microgranular | | |
| | Micronised | | |
| | (wettable | | |
| | powder type) | | |
| Mixed inoculum | | | 5 × 10⁶ |
| | | | C.F.U./g |
| Mycorrhizae | | 16% | |
| (crude inoculum) | | | |
| Rhizosphere | | 4% | |
| bacteria | | | |
| Trichoderma spp. | | 4% | |
| Inerts | | 40% | |
| sepiolite | | | |
| and/or bentonite | | | |
| and/or zeolite | | | |
| and/or kaolin | | | |
| and/or lapilli | | | |
| Total | | 100% | |

TABLE 3

| | | Percentage | Biological |
|---|---|---|---|
| | | composition | composition |
| Components | Formulation | (by weight) | (minimum) |
| Biosurfactants + | Micronised | 100% | 5 × 10⁶ |
| Inerts kaolin | (wettable | | C.F.U./g |
| and/or bentonite | powder type) | | |

### Application Modalities for the Plant Inoculum (Microbiological Consortium)

In an embodiment at present preferred, the application modality of the microbiological consortium of the rhizosphere may be summed up as follows.

When the consortium is used to dress the seeds directly, to obtain better adhesion to the seeds it may be glued with the usual glues utilised to dress seeds, in this case a concentrated product is necessary, to be used at a rate of 200 g/400 g per hectare dose of seeds to be dressed.

In mixing into loam and peat used in seedbeds for the production of young plants and cuttings the consortium is used at a recommended dose of 15 litres per m³ of loam or peat.

When the distribution is done at the time of sowing in the field, the consortium is directly distributed by sowing machines provided with micro-granulators, at a dose equal to approximately 13-20 litres per hectare.

In the case of broadcasting seed in cultivation beds, the consortium is distributed directly before sowing or before transplanting the seedlings, at a dose of approximately 100 litres/hectare.

In the direct distribution in cultivation structures, the consortium is distributed slightly buried, with light harrowing or using an injector pole, and the dose is of 100-200 litres/hectare.

### Example

### Elimination of PCBs from Agricultural Land

The Applicant has discovered that the use of mycorrhizae and bacteria of the rhizosphere comprises a surprisingly advantageous tool to eliminate almost entirely the presence of organic pollutants in the soil, exploiting the metabolic processes of these micro-organisms facilitated by the presence of bio-surfactant agents. At the same time, the Applicant has verified that the use of a microbiological consortium of the rhizosphere reduces the passage of chemical pollutants into the food chain thanks to the metabolic work of the cytochromes P450 and of the conjugation enzymes present in the mycorrhizal fungi and in the bacteria of the rhizosphere.

Table 4 provides data concerning the presence of enzymes charged with the metabolising carcinogenic substances in each of the micro-organisms present in the microbiological consortia of the rhizosphere tested by the Applicant.

TABLE 4

| SPECIFIC | BACILLUS | PSEUDOMONAS | | |
|---|---|---|---|---|
| ACTIVITY | SUBTILIS | FLUORESCENS | TRICHODERMA | GLIOCLADIUM |
| CATALASE ^{a} | | 23.34 ± 0.01 | 150.45 ± 30.09 | 8 ± 1.6 |
| DT-DIAPHORASE ^{b} | 114.44 ± 20.24 | 30.15 ± 8.23 | 66.35 ± 15.82 | 25.70 ± 10.45 |
| ECOD ^{c} | 0.162 ± 0.011 | n.d. | 0.685 ± 0.137 | 0.84 ± 0.61 |
| GLUTATHIONE | | 1.77 ± 0.37 | 5.94 ± 2.64 | 2.81 ± 0.81 |
| PEROXIDASE ^{b} | | | | |
| GLUTATHIONE | | 82.08 ± 25.34 | 3.93 ± 0.88 | 17.11 ± 7.22 |
| REDUCTASE ^{b} | | | | |
| GLUTATHIONE-S- | n.d. | n.d. | 9.34 ± 1.868 | n.d. |
| TRASFERASE | | | | |
| NADPH CYTOCHROME | 26.81 ± 4.95 | 5.24 ± 1.61 | 7.12 ± 3.99 | 3.28 ± 0.92 |
| C-REDUCTASE ^{c} | | | | |
| SUPEROXIDE | | 5.50 ± 2.05 | 250.3 ± 26.45 | 23.58 ± 13.13 |
| DISMUTASE ^{d} | | | | |

^{a} Specific activity expressed in μmol/min × mg prot.
^{b} Specific activity expressed in nmol/min × mg prot.
^{c} Specific activity expressed in pmol/min × mg prot.
^{d} Specific activity expressed in U/mg prot.
n.d. Activity not determinable

The trials were performed evaluating in particular the polychlorinated biphenyls or PCBs [1-6].

PCBs comprise a group of 209 congeners [2] produced by the chlorination of two benzene groups connected by a single bond; they may be subdivided into ten families of isomers from mono to deca according to the number of substituent chlorine atoms. Thus PCBs are characterised by a great variability of structure, with chlorine atoms in the ortho, meta and para positions, with a strong spatial symmetry or asymmetry that ranges from complete planarity of the two benzene groups, to non-planarity, in which the benzene rings are at 90° to each other. The number and position of the chlorine atoms conditions and governs the accumulation and persistence of the different congeners in different environmental matrices, as a consequence of the different chemical and biological reactivity; the chemical, chemico-physical and toxicological properties are equally variable, determining fate and dangerousness. The single congeners are indicated by an increasing numbering, known as the BZ number, from Ballschmiter and Zell who drew up the classification in 1980, which follows the IUPAC characterisation to determine the position of the chlorine atoms. For example, PCB 126 indicates the congener 3,3′,4,4′,5 penta-CB.

The microbiological consortium of the rhizosphere was applied to the soil to be decontaminated with the contents illustrated in Tables 2 and 3.

Obviously, those who are experts in the field will carry out the necessary analyses to check any pathogenicity of the individual strains of the various micro-organisms comprising the microbiological consortium of the rhizosphere to be used, in order to avoid using strains that are pathogenic for the plants, as well as if possible optimising the quantities of consortium and of bio-surfactant to be used, simply by making use of their general knowledge.

The decontamination procedure involves sowing annual plants on the land to be decontaminated, their function being that of providing a support for the development of the microbiological consortium of the rhizosphere. Plants that may be utilised to advantage are all those annual plants characterised by rapid growth of the root apparatus, which in fact acts as a support for the development, for example, of saprophytic fungi, endomycorrhyzae, bacteria and actinomycetes of the rhizosphere. The trials were carried out using maize and hemp in the case of agricultural land. To advantage, graminaceae and clover or lawn grasses may also be used, for example, in the case of green urban areas.

The trials carried out by the Applicant on soil contaminated by PCBs entailed seven experimental lots being marked out, each of the size of 210 m², as is indicated in diagram form in Table 5.

TABLE 5

| Lot | Crop | Treatment |
|---|---|---|
| 1 | Hemp | control |
| 2 | Hemp | mycorrhization |
| 3 | Hemp | mycorrhization + bio-surfactant |
| 4 | Maize | control |
| 5 | Maize | mycorrhization |
| 6 | Maize | mycorrhization + bio-surfactant (cyclodextrins) |
| 7 | Maize | mycorrhization + bio-surfactant (Pichia pastoris) |

The chief criterion followed in the choice of agricultural crop to be used in the experimental lots was to select crops with a high capacity to produce biomass and that is capable of optimising the cleansing cycle of the ground, where such crops in part belong to the food chain (maize, soy) and in part belong to the industrial production chain, such as hemp.

In regard to the mycorrhization, it was decided to use three strains of symbiotic fungi of the genus Glomus, and in particular G. caledonicum, G. intraradice and G. coronatur. With regard to bacteria of the rhizosphera, Pseudomonas borealis, Pseudomonas fluorescens and Bacillus subtilis were selected. Among the saprophytic fungi, Trichoderma harzianum was selected.

With regard to the bio-surfactant—necessary to increase the solubility of the PCBs—cyclodextrin was used (a non-reducing cyclic saccharide produced by the enzymatic action of micro-organisms on partially hydrolised starch). The quantity of bio-surfactant used per lot was approximately 0.15 kg/m³. As an alternative to cyclodextrin, a bio-surfactant bacterium was used, the yeast Pichia pastoris.

The inoculum presents as a granular substance mixed to powder, with maximum granulometry of 0.3 mm and it is distributed, for example in the cultivation of maize, at the time of sowing employing the micro-granulator present in sowing machines. The dose of microbiological consortium to be distributed per hectare is approximately 18 litres per hectare.

The results of the procedure to decontaminate the land have shown that, in one year, it is possible to achieve a reduction of 30-50% by weight of PCBs present in the soil, which entails the application of the procedure according to the present intervention for a length of time of two to three years to achieve complete decontamination of the soil.

The concentration of PCBs present in the different portions (stem, leaves, roots and grain in the case of maize) of plants cultivated on polluted land following the modalities of the present intervention were also determined. The results provided in Table 6 indicate that the cultivated plants will be usable for human and animal food starting from the second year in which the procedure according to the present intervention is put in place, since the microbiological consortium of the rhizosphere has acted as a filter to the absorption of PCBs into the plant, with excellent results already in the first year.

TABLE 6

| CROP | TREATMENT | TOT | Stem + Leaves | Root | Grain |
|---|---|---|---|---|---|
| HEMP | control | 52.73 | 10.51 | 42.22 | — |
| HEMP | M* | 57.45 | 18.43 | 39.02 | — |
| HEMP | M + BB** | 26.10 | 4.48 | 21.62 | — |
| HEMP | M + B*** | 37.55 | 14.97 | 22.58 | — |
| mean conc. PCBs | | 43.45 | | | |
| MAIZE | control | 42.42 | 11.54 | 27.22 | 3.66 |
| MAIZE | M* | 29.29 | 9.50 | 18.56 | 1.23 |
| MAIZE | M + BB** | 14.25 | 5.08 | 6.51 | 2.66 |
| MAIZE | M + B*** | 10.75 | 1.41 | 8.17 | 1.17 |

| | |
|---|---|
| mean conc. PCBs | 24.27 |

*M = mycorrhization
**M + BB = mycorrhization + bio-surfactant bacterium
***M + B = mycorrhization + bio-surfactant

Naturally, production details and embodiments may be widely varied with respect to what is described and illustrated without thereby departing from the sphere of protection of the present invention, as defined by the attached claims.

### REFERENCES

1. ATSDR (Agency for toxic substances and Disease Registry), (2000), “Toxicological profile for polychlorinted biphenyls”. Atlanta: ATSDR, draft for public comment.
2. ENVi-MOD, SMIC (2003) “Considerazioni in merito alle problematiche per la condotta dell'analisi di rischio da PCB” 8th International conference on Contaminanted Soil Belgium May 12-16, 2003.
3. Institute for Evaluating Health Risks (1991), “Reassessment of liver findings in five PCBs studies rats”. Washington D.C; Dated July 1. Report submitted to U.S EPA IRIS Integrated Risk Information System, US EPA; www.epa.gov/iris
4. National Cancer Institute (1978) “Bioassay of Aroclor 1254 for possibile carcinogenity” Carcinogenesis Tech. Rep Ser. No. 38
5. U.S APA Environmental Protection Agency (1991) “Workshop report on toxicity equivalency factors for polychlorinated biphenyls congeners” Risk. Assessment Forum, Washington D.C Report No EPA/625/3-91/020.
6. WHO World Health organization (1993) “Polychlorinated biphenyls and terphenyls” Geneva: WHO, Environmental Health Criteria 140, II ed.

1. Procedure to decontaminate a large area of land from organic pollutants, including the phases of:
a. sowing and cultivating an annual and/or perennial plant on the land to be decontaminated;
b. inoculating the plant with a microbiological consortium of the rhizosphere; and
c. applying at least one surfactant substance to the land,
where the metabolic activity of the microbiological consortium of the rhizosphere causes decomposition of the organic pollutants present in the soil.

2. Procedure according to claim 1, characterised in that said consortium comprises at least two among mycorrhizal fungi, actinomycetes, bacteria of the rhizosphere, saprophytic fungi, micromycetes.

3. Procedure according to claim 2, characterised in that said mycorrhizal fungi are selected from among fungi of the genera Glomus, Acaulospora, Gigaspora and Scutellospora.

4. Procedure according to claim 3, characterised in that said mycorrhizal fungi are selected from among fungi of the species Glomus coronatum, G. celedonium, G. intreradices, G. mosseae, G. viscosum, G. glomaceae, G. fasciculatum, G. claroideum, G. etunicatum, G. epigaeum, G. lamellosum, G. monosporum, Acaulospora longula, A. laevis, Gigaspora ramisporophora, G. gigantea, G. rosea, G. calospora, Scutellospora calospora.

5. Procedure according to claim 2, characterised in that said actinomycetes are selected from among actinomycetes of the genus Streptomyces spp.

6. Procedure according to claim 5, characterised in that said actinomycetes are selected from among actinomycetes of the species Streptomyces griseus and S. avernichilis.

7. Procedure according to claim 2, characterised in that said bacteria of the rhizosphere are selected from among bacteria of the genera Pseudomonas, Bacillus, Enterobacteriaceae, Paenibacillus, Alcanivorax, Candida, Rhodococcus, Acitenobacter, Mycobaterium, Serratia and Agrobacterium.

8. Procedure according to claim 7, characterised in that said bacteria of the rhizosphere are selected from among bacteria of the species Pseudomonas borealis, P. fluorescens, P. synxantha, P. corrugata, P. aeroginosa, P. cloraraphis, P. trivalis, P. favisporuns, A. vanetianus, R. rythropolis, A. calcoacetiucus, A. radioresistens, M. thermoautotrophium, S. marcescens, A. radiobacter, B. substilis, B. magaterium, B. polymyxa, B. licheniformis.

9. Procedure according to claim 2, characterised in that said saprophytic fungi are selected from among fungi of the genera Trichoderma, Coniothyrium, Beauveria and Gliocladium.

10. Procedure according to claim 9, characterised in that said saprophytic fungi are selected from among fungi of the species T. hartzianum, T. viridae, T. aureoviridae, T. atroviridae, T. koningii, T. virens, T. an. of Hypocrea schwilinitzi, C. minitans, G. calenulatum, B. bassiana.

11. Procedure according to claim 2, characterised in that said micromycetes are selected from among fungi of the genera Mortierella, Aspergillum, Sclerotium, Ulocladium, Arthrobotrys and Mucor.

12. Procedure according to claim 11, characterised in that said micromycetes are selected from among micromycetes of the species M. isabellina, A. niger, U. oudemansii, A. oligospora.

13. Procedure according to claim 1, characterised in that said surfactant is a bio-surfactant or a bio-surfactant bacterium.

14. Procedure according to claim 13, characterised in that said bio-surfactant is of natural or synthetic origin.

15. Procedure according to claim 14, characterised in that said natural bio-surfactant is selected from among the cyclodextrins.

16. Procedure according to claim 14, characterised in that said synthetic bio-surfactant comprises a polyethylene sorbitol ester.

17. Procedure according to claim 13, characterised in that said bio-surfactant bacterium is selected from among Pichia pastoris, Acinetobacter calcoaceticus, Acinetobacter radioresistens, Pseudomonas aeruginosa, Rhodococcus spp., Bacillus subtilis, Candida bombicola, Alcanivorax borkumensis, Alcanivorax venetianus.

18. Procedure according to claim 1, characterised in that said organic pollutants comprise azoto-sulpho-organics, azoto-organics, phosphorganics, chlororganics, alohydrocarbons, neonicotinoids, phenoxy derivatives, dioxins and aromatic polycyclic hydrocarbons.

19. Procedure according to claim 1, characterised in that said organic substances are polychlorinated biphenyls.

20. Use of a microbiological consortium of the rhizosphere, in association with a bio-surfactant and the cultivation of an annual and/or perennial plant for the decontamination of large areas of land from organic pollutants.
